(19) United States
(12) Patent Application Publication
(10) Pub. No.: US 2003/0111293 A1
(43) Pub. Date: Jun. 19, 2003

(54) FALL ARREST SYSTEM WITH FLOW-THROUGH INTERMEDIATE SUPPORT

(76) Inventors: Marc J. Desjardins, Val Caron (CA); David A. Duval, Lively (CA)

Correspondence Address: Mike M. Gauthier, 1264156 Ontario Incorporated, o/a Intel-Pro Design and Mfg., 959 Elisabella Street, Unit C,, Sudbury, ON, P3A 5K1, CA

(21) Appl. No.: 10/011,461

(22) Filed: Dec. 13, 2001

(51) Int. Cl. A62B 1/16

(52) U.S. Cl. 182/36; 182/3

(57) ABSTRACT

A fall arrest system with flow-through intermediate supports which allow the travel of one or more load-connecting devices along a length of horizontal lifeline cable supported by intermediate supports. The load-connecting device having an upper cable contacting portion of greater outside diameter than the narrow opening at the bottom of the intermediate supports. In the event of a fall, the load-connecting device pulls the cable downward while the cable remains within the inner portion of said intermediate supports. Outward tension of the cable in maintained by a tension control device while the chock to the load is absorbed by said tension control device located between the cable and one of the cable-end anchors.

### FIELD OF THE INVENTION

The present invention relates to a fall arrest system adapted with both flow-through intermediate supports and a tension control device. The system of the present invention consists of; floor-level end anchors mounted to structural members of a work area, a single cable assembly having one permanent end connector and one adjustable loop-end connector at the opposing end, cable-tensioning means utilizing a rotable tension adjusting turnbuckle, tension control means having a generally diamond shapes frame adapted to connect two opposing ends of said frame in communication with cable and end connectors, a plurality of intermediate supports having a mounting portion at the top, said intermediate supports each consisting of a generally square tubular form adapted with a bottom opening lesser in width than that of the diameter of the above-mentioned cable, and a load-connecting device having a cable-connecting portion and a load-connecting portion. Whereby, a load attached firmly and releasable to the cable contacting means can freely travel longitudinally with the fixed cable, occasionally passing through fixedly attached intermediated supports so as to provide unobstructed flow from one end of the cable to the other.

### BACKGROUND OF THE INVENTION

Horizontal lifelines are generally a single span of semi-resilient cable fixedly anchored at each extremity. Persons or loads are thereto slidably attached in order to be provided with fall arrest and travel restraint. When this span becomes greater than that allowed by regulating authorities, intermediate supports are required. Unless through-travel is provided, a person would be required to disengage lifeline from cable in order to overcome said supports.

It is desirable to persons working at high altitudes to have the ability to be secured to a suitable anchorage to prevent or arrest potential falls, which could result in serious injury of death. Additionally, it is also desirable to have the ability to freely displace oneself along the length of the work area while remaining attached to said horizontal lifeline. Furthermore, in the event of a fall, it is again desired that the force created by such fall arrest be minimized in order to prevent injuries. The present invention not only satisfies the above-mentioned desires in fall arrest, but also provides the present state of the art with means of improving the travel means across intermediate supports and means to minimize the forces created by a fall.

The applicant is aware of several attempts in prior art to provide means of arresting the fall of a person from dangerous heights. For example, reference may be had to U.S. Pat. No. 5,979,599 of Noles, issued Nov. 9, 1999, which describes a track apparatus that allows for directional conformity having track supports intermediately fixed to points along the structural members of the work area, a track-traveling element conforming generally to the profile of said track supports. Although this fall arrest system may surely arrest a fall, it fails to provide shock absorption elements that are crucial to the benefit of injury prevention. Furthermore, the user must align the profiles of the anchor and support in order to uninterruptedly travel across track supports.

Another example of prior art may be had in referring to U.S. Pat. No. 5,526,896 of O'Rourke, issued Jun. 18, 1996, which depicts a fixed rail anchor system whereby an anchor is fixedly mounted to a rail, provide a fixed point to which an anchor line may be attached. Said method fail to allow free travel to substantial distances along the work area.

While many attempts have been made to provide persons or loads with fall arresting means, none of the prior art found provide all the desired functions in a singular system.

### SUMMARY OF THE INVENTION

It is thus the object of the present invention to provide fall arresting elements to a virtually limitless length of work area while also providing tension control in the event of a fall, and a more liberal margin of accuracy for intermediate support through-travel.

In one aspect of the invention, there is provided a floor intermediate support having a mounting plate fixedly attached to said support. There are provided, vertical angular ribs on each side of the floor intermediate support and on top of the mounting plate, all fixedly attached. Said angular ribs provide ramp means in order for heavy materials to be displaced horizontally over the surfaces of floor intermediate supports.

In another aspect of the invention, any suitable tension control means may be utilized in place of the tension control device of the preferred embodiment.

In another aspect of the invention, any other suitable cable end anchor may be utilized to anchor cable ends to work area.

Accordingly, the system of the present invention provides unobstructed mobility within the system's fall arresting work area while incorporating tension control elements and a more liberal margin of accuracy for intermediate support through-travel.

The utility of this device includes but is not limited to persons.

### BRIEF DESCRIPTION OF THE DRAWINGS

These and other advantages of the invention will become apparent upon reading the following detailed description and upon referring to the drawings in which:

FIG. 1A is a side elevation view of the fall arrest system of the present invention, shown in undetermined length with no vertical gravitational load.

FIG. 1B is a side elevation view of the fall arrest system of the present invention, shown in undetermined length with a vertical gravitational load.

FIG. 2 is a perspective view from above of the floor-level end anchor of the fall arrest system of the present invention.

FIG. 3 is a top plan view of the floor-level end anchor of FIG. 2.

FIG. 4 is a side elevation view of the floor-level end anchor of FIG. 2 FIG. 5 is an end elevation view of the floor-level end anchor of FIG. 2.

FIG. 6 is a perspective view from above of the floor-level intermediate support of the fall arrest system of the present invention.

FIG. 7 is a top plan view of the floor-level intermediate support of FIG. 6.

FIG. 8 is a side elevation view of the floor-level intermediate support of FIG. 6 showing a cable passing through said floor-level intermediate support along with the load-connecting device of the present invention.

FIG. 9 is a end elevation view of the floor-level intermediate support of FIG. 6 showing a cable passing through said floor-level intermediate support along with the load-connecting device of the present invention.

FIG. 10 is a perspective view from below of the overhead intermediate support of the fall arrest system of the present invention.

FIG. 11 is a bottom plan view of the overhead intermediate support of FIG. 10.

FIG. 12 is a side elevation view of the overhead intermediate support of FIG. 10 showing a cable passing through said overhead intermediate support along with the load-connecting device of the present invention.

FIG. 13 is an end elevation view of the overhead intermediate support of FIG. 10 showing a cable passing through said overhead intermediate support along with the load-connecting device of the present invention.

FIG. 14 is a perspective view from above of the load-connecting device of the fall arrest system of the present invention

FIG. 15 is a side elevation view of the load-connecting device of FIG. 14 showing a cable passing through said load-connecting device.

FIG. 16 is an end elevation view of the load-connecting device of FIG. 14 showing a cable passing through said load-connecting device.

FIG. 17 is a perspective view from above of the tension control device of the fall arrest system of the present invention.

FIG. 18 is a side elevation view of the tension control device of FIG. 17 as shown without load to the system.

FIG. 19 is an end elevation view of the tension control device of FIG. 17.

FIG. 20 is a side elevation view of the tension control device as shown with a load to the system.

FIG. 21 is an end elevation view of the tension control device of FIG. 20.

FIG. 22 is a top plan view of the tension control device of FIG. 17.

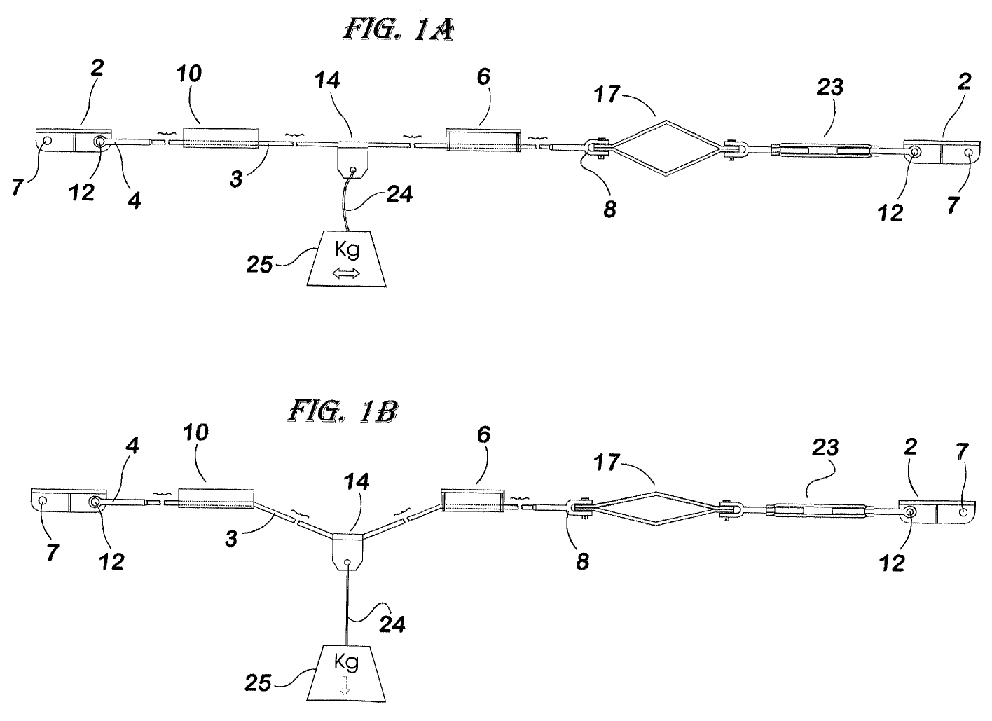

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

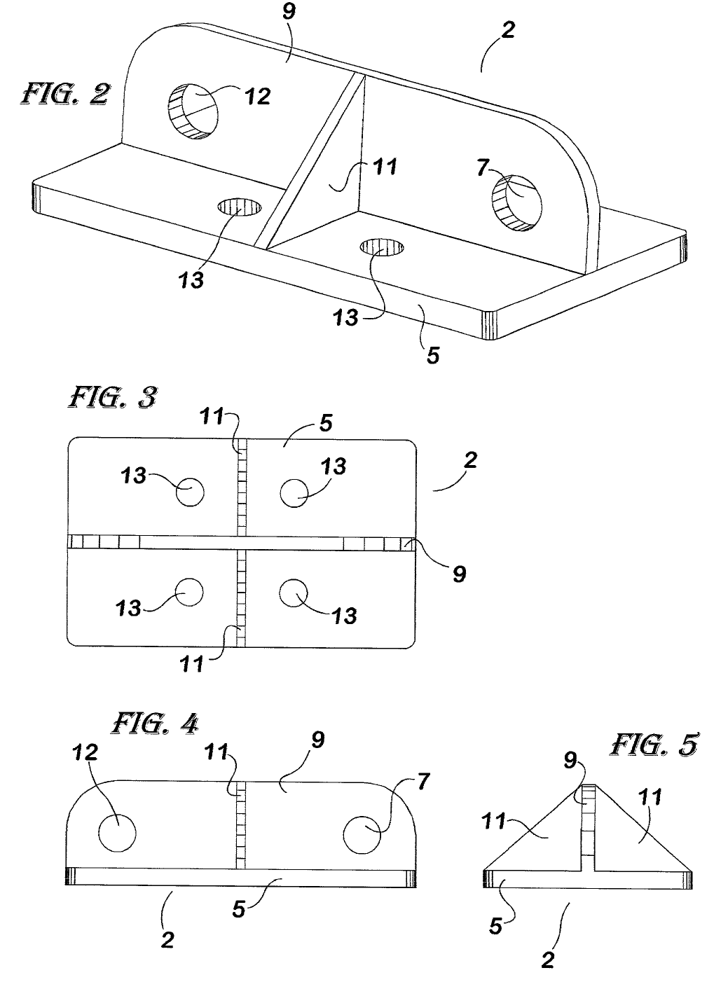

Turning to the drawings, in particular, FIG. 2 which illustrates an embodiment of a floor-level end anchor 2 comprising: a rectangular mounting plate 5 having a plurality of perforations 13 through which fasteners penetrate to fixedly attach floor-level end anchor 2 to a structural member of the work area, a center rib 9 permanently attached to the center portion of the mounting plate 5 and reinforced with triangular ribs 11 permanently attached to both the bottom surface of mounting plate 5 and each side of the center ribs 9. Said triangular ribs 11 primarily serve the function of allow materials to slidably traverse over the upper surfaces of the floor-level end anchor. Perforations 7 and 12 are provided centrally near each end of the center rib 9 to allow cable connectors 4 to connect thereto.

Turning now to FIG. 3, a top plan view of the floor-level end anchor 2 of the present invention wherein said end anchor comprises: a rectangular mounting plate 5 having a plurality of perforations 13 through which fasteners penetrate to fixedly attach floor-level end anchor 2 to a structural member of the work area, a center rib 9 permanently attached to the center portion of the mounting plate 5 and reinforced with triangular ribs 11 permanently attached to both the top surface of mounting plate 5 and each side of the center ribs 9. Said triangular ribs 11 primarily serve the function of allow materials to slidably traverse over the upper surfaces of the floor-level end anchor. Perforations 7 and 12 are provided centrally near each end of the center rib 9 to allow cable connectors 4 to connect thereto.

Referring now to FIG. 4, a side elevation view of the floor-level end anchor 2 of the present invention depicting the location of the center rib 9 perforations 7 and 12 wherein the upper outer portions of the center rib 9 is rounded to allow radial flexibility of the attached cable connector 4. The figure also shows the side view of one of the triangular ribs 11 centrally located along the face of the center rib 9.

In reference now to FIG. 5, an end elevation view of the floor-level end anchor 2 of the present invention, wherein the triangular ribs 11 are shown depicting their function is allowing materials to be slidably traversed along the upper surfaces of said end anchor 2.

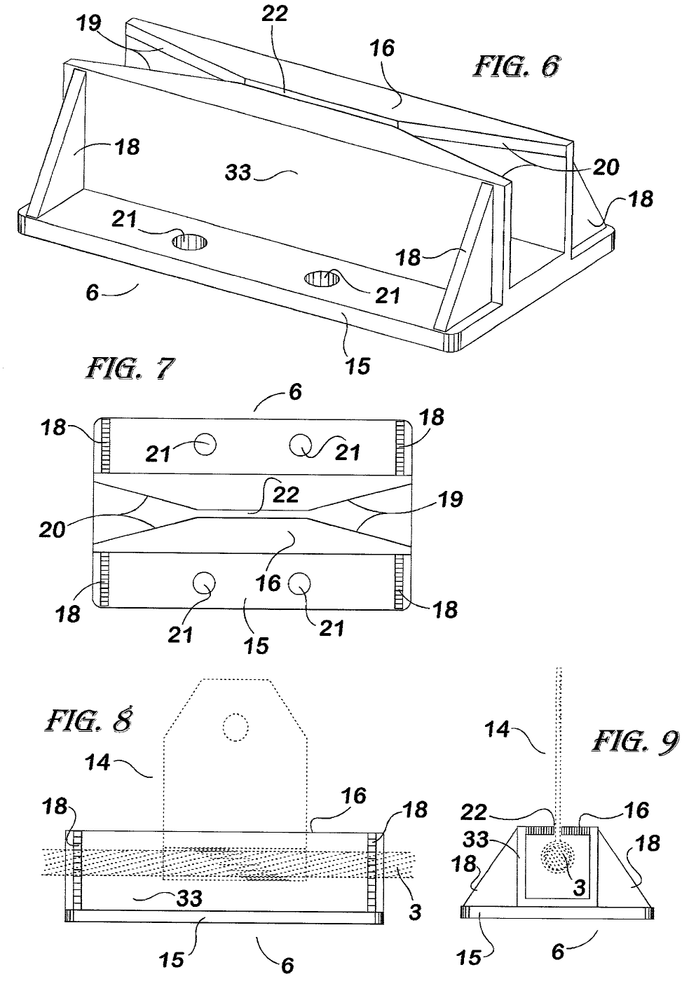

Referring now to FIG. 6, a perspective view from above of a floor-level intermediate support 6 comprising: generally rectangular mounting plate 15 permanently attached to a generally square tubular cable channel 33 of generally equal length to that of the mounting plate 15. The mounting plate 15 is adapted with perforations 21 so as to allow fasteners to penetrate the mounting plate 15 and be fastened to structural members of the work area. The upper surface 16 of the cable channel 33 is milled in such a way to form wide openings 19 and 20—at each extremity of the upper portion 16 of the cable channel 33—gradually decreasing in width to a central area 22 of said upper surface 16 where said narrow opening 22 is generally one half the width of a cable's diameter so as to avoid a cable from exiting the cable channel 33. Triangular reinforcing supports 18 are permanently attached to both the top of the mounting plates 15 and each side of the cable channel 33. Said triangular ribs 18 primarily serve the function of allow materials to slidably traverse over the upper surfaces of the floor-level intermediate support.

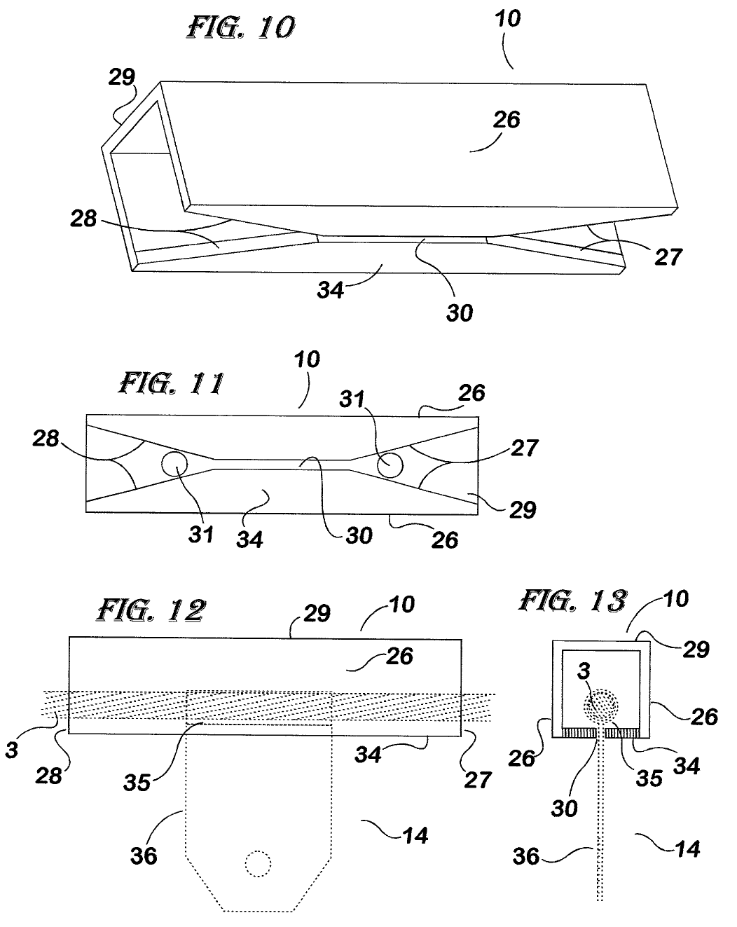

Referring now to FIG. 10, a perspective view from below of an overhead intermediate support 10 comprising: a generally square tubular shaped steel form having a top portion 29, downwardly protruding sides 26 and a bottom portion 34. The bottom portion 34 of the overhead intermediate support 10 is milled in such a way that wide openings 27 and 28 gradually decrease in width to a central opening 30 of said bottom portion 34 where said narrow opening 30 is generally one half the width of a cable's diameter so as to avoid a cable from exiting the overhead intermediate support 10.

Turning to FIG. 11, a bottom plan view of the overhead intermediate support 10 of FIG. 10 depicting perforations 31 near each end of the top portion through which fasteners penetrate to fixedly attach overhead intermediate support 10 to a structural member of the work area.

Referring now to FIGS. 12 and 13. FIG. 12 as a side elevation view and FIG. 13 as an end elevation view of an overhead intermediate support 10. Said overhead intermediate support 10 depicted housing a horizontal lifeline cable 3 having a diameter greater than twice the width of the narrow opening 30 of the bottom portion 34 of the overhead intermediate support 10, and a load5 connecting device 14 having a cable connecting portion 35 and a load engaging means 36. The inner portion 42 of the cable-connecting portion 35 of the load-connecting device 14 fully surrounds the outside diameter of the horizontal lifeline cable 3 allowing liberal longitudinal movement of the load-connecting device 14 with the horizontal lifeline cable 3 while freely traversing the cable channel of the overhead intermediate support 10.

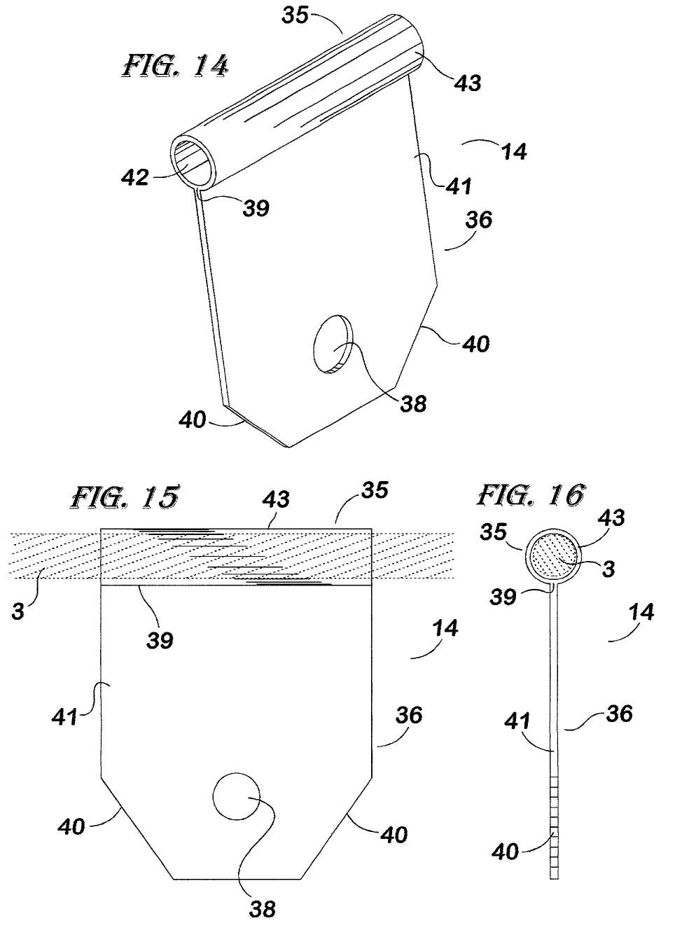

Referring now to FIG. 14, a perspective view from above of a load-connecting device 14 having an upper cable-connecting portion 35 and load connecting means 36. The cable-connecting portion 35 of the load-connecting device 14 is generally cylindrically shaped with a length approximately four times that of its diameter, and a load-engaging portion 36 having a generally vertically planar surface 41, a perforation 38 and diagonal lower corners 40 to allow angular swaying of a load connector. Whereby, a load attached firmly and releasable to the load engaging portion 36 can freely travel longitudinally with the fixed cable 3, occasionally passing through firmly fixed intermediated supports 6 and/or 10 so as to provide unobstructed flow from one end of the cable to the other.

With reference now to FIGS. 15 and 16. FIG. 15 as a side elevation view and FIG. 16 as an end elevation view of load-connecting device 14 wherein said device 14 travels freely and longitudinally with cable 3.

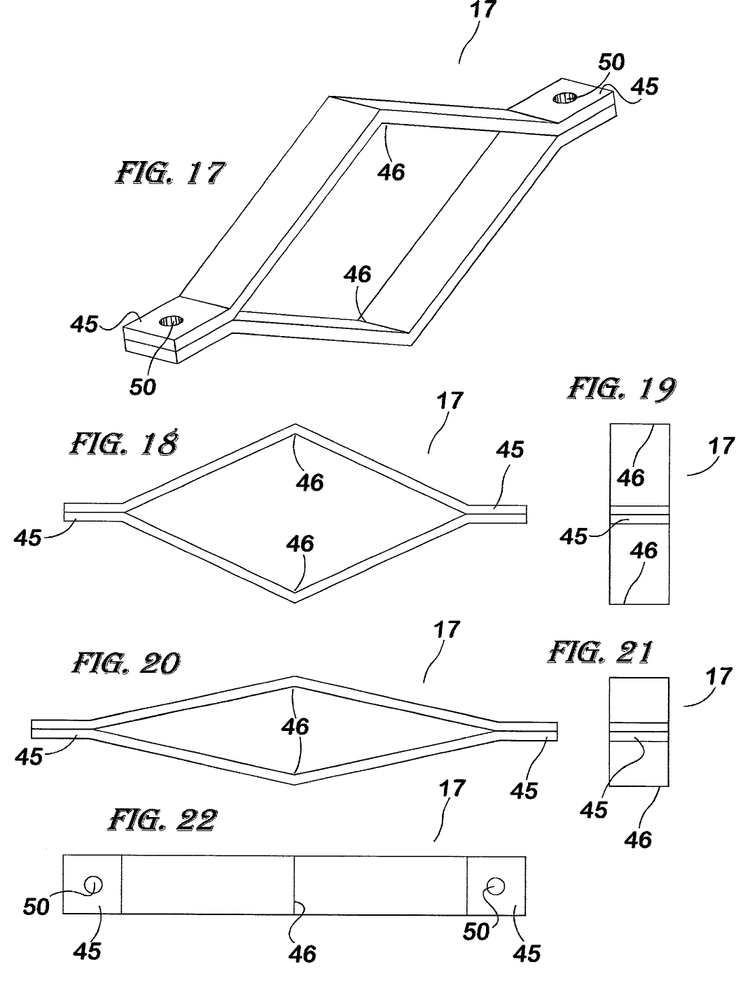

Turning now to FIGS. 17 to 19 wherein FIG. 17 is a perspective view from above, FIG. 18 a side elevation view, and FIG. 19 an end elevation view of the tension control device 17 of the fall arrest system of the present invention comprising: generally planar bars wherein the upper bar is formed to have a raised center portion 46, bends at each end of the bar so as to form a generally horizontal plane from one end to the other whereby, when two of these formed bars placed together in a mirrored fashion would form a diamond shaped structure.

With reference now to FIG. 22 a top plan view of the tension control device 17 showing the perforations 50 located at the central regions of each connecting end. Said perforations 50 align when two of these formed bars placed together in a mirrored fashion.

Turning now to FIG. 20, which depicts the tension control device 17 of the fall arrest system of the present invention having horizontally outward tension applied thereto. When great tension is applied to the cable 3 of the system, the central portions 46 of the device draw inwardly toward the center of the tension control device 17 assembly. Furthermore the tension control device 17 also assists in absorbing the chock to a load in the event of a fall arrest by compressing its center portions 46 thus elongating the end portions 45 of the tension control device 17.

Lastly, turning to FIG. 21, depicting the end elevation view of a tension control device 17 of the present invention as great tension is applied to the cable thus gradually drawing the opposing centers 46 of the device 17 closer together.

The embodiments of the invention in which an exclusive property or privilege is claimed are defined as follows:/What I claim as my invention:

1. A fall arrest system with flow-through intermediate supports comprising:
a. a floor-level end anchor comprising: a rectangular mounting plate having a plurality of perforations for fastening to structural members of a work area, a center rib portion of equal length to that of the mounting plate fixedly and upwardly attached to center length of said mounting plate, one perforation near each end of center rib portion so as to allow fastening of cable connectors to said floor-level end anchor,
b. a floor-level intermediate support comprising: a rectangular mounting plate having a plurality of perforations for fastening to structural members of a work area, a generally square tubing portion upwardly and fixedly attached to center length of said mounting plate having a lower mounting-plate connecting portion, two upwardly protruding side members and inwardly protruding upper members adapted with a central opening having larger openings at each extremity narrowing inwardly to the narrowest portion of said opening,
c. an overhead intermediate support having an upper mounting portion with two perforations for fastening to structural members of a work area, two downwardly protruding side members, and inwardly protruding bottom members adapted with a central opening having larger openings at each extremity narrowing inwardly to the narrowest portion of said opening,
d. a load-connecting device comprising: an upper horizontal cylindrical tube having a length of approximately four time its diameter, a lower load-attaching portion—fixedly and downwardly attached to said upper cylindrical tube—having a generally thin vertically planar member with a perforation at the lower central region of said load-attaching portion and angular lower bottom corners,
e. a tension control device comprising two flat bars portions having a single perforation near each end, one upper flat bar having a central point extending downwardly and outwardly then only outwardly to form planar ends, and one lower portion mirroring the upper portion so that when both portions meet, form a diamond shaped opening between said upper and lower portions,

2. The various accessories of claim 1 wherein said accessories are fabricated of a highly resilient metallic material.

3. The floor-level end anchor of claim 1 wherein perforations in the mounting plate may be optionally located at any area of said mounting plate.

4. The floor-level intermediate support of claim 1 wherein the larger openings at each extremity of the lower cable-housing portion gradually decrease inwardly to a narrow opening of lesser width than the diameter of a lifeline cable.

5. The overhead intermediate support of claim 1 wherein the larger openings at each extremity of the lower cable-housing portion gradually decrease inwardly to a narrow opening of lesser width than the diameter of a lifeline cable.

6. The load-connecting device of claim 1 wherein the upper cable contacting portion and the lower load-attaching portion are fixedly and permanently attached to each other.

7. The load-connecting device of claim 6 wherein the upper cable-connecting portion has a greater inside diameter than that of the outside diameter of a lifeline cable.

8. The tension control device of claim 1 wherein the width and thickness of the material can be varied to alter the weight bearing capability of the tension control device.

9. The tension control device of claim 8 wherein resilient vertical springs may be added to the central inner region of the device so as to provide flexibility to the device.

10. The load-connecting device of claim 6 wherein the thickness of the lower load-connection portion is lesser than the narrow opening of the intermediate supports of the present invention.

11. The load-connecting device of claim 7 wherein the outside diameter of the upper cylindrically tubular portion of the load-connection device is larger than the narrow opening of the intermediate supports of the present invention.
